(19) United States
(12) Patent Application Publication
(10) Pub. No.: US 2010/0305235 A1
(43) Pub. Date: Dec. 2, 2010

(54) Anticorrosive Nanocomposite Coating Material, and a Preparation Process Thereof

(75) Inventors: Ying-Man LAM, Taipei (TW); Darren HALL, Taipei (TW); Shir-Joe LIOU, Taipei County (TW)

Correspondence Address: SCHMEISER OLSEN & WATTS, 18 E UNIVERSITY DRIVE, SUITE # 101, MESA, AZ, 85201, US

(73) Assignee: BRIGHTEN ENGINEERING CO., LTD., Taipei City (TW)

(21) Appl. No.: 12/857,058

(22) Filed: Aug. 16, 2010

Related U.S. Application Data
(62) Division of application No. 12/269,699, filed on Nov. 12, 2008.

(51) Int. Cl. C08K 9/00; C08K 3/34

(52) U.S. Cl. 523/209; 524/445

(57) ABSTRACT

The invention relates to an anticorrosive nanocomposite coating material that comprises polyurea, organophilic clay and suitable additives, and is useful for preparing a polyurea/clay nanocomposites; whereby said nanocomposite coating material is coated on a substrate to greatly decrease the corrosion rate of the substrate; wherein said polyurea is combined from an amino terminated compounds and a isocyanate compound. The invention also provides a process for preparing said nanocomposite coating material, said process comprising: mixing homogeneously said amino terminated compound and an organophilic clay, followed by mixing homogeneously with isocyanate compound and suitable additives at a proper ratio, wherein, after a polymerization reaction, said organophilic clay can achieve a nano-scale dispersion extent, thereby obtaining said anticorrosive nanocomposite coating material.

### BACKGROUND OF THE INVENTION

1. Field of the Invention

The invention relates to a novel nanocomposite coating material and to a process for preparing the same, and in particular, to an anticorrosive nanocomposite coating material and a preparation process thereof.

2. Description of the Prior Art

A coating material such as paint or lacquer form a thin film coating on a substrate and thereby act mainly as surface finish or protection for the substrate. Conventional coating materials include generally, commercial cement mortar, latex paint and the like. They are composed mainly of organic chemical synthetic material, and therefore, contain a certain amount of volatile organic substances and heavy metals. Organic solvents not only have an irritable odor, but are also corrosive and toxic, which may dramatically affect the human respiratory system, and may be extremely hazardous to human health and even pose a carcinogenic risk. Traditional coating materials also have limitations in their application. For example, a traditional coating material cannot completely adhere to the surface of all organic or inorganic substrates. Further, since the structure of the traditional coating material is less compact, it is susceptible to oxidation, corrosion or peeling upon exposure to air, sun or rain, which tends to reduce the use life of the substrate. In addition, the substrate can become exposed, rusted, denatured or deformed and thereby pose a risk of accident. Obviously, the traditional coating material can not meet the present need.

Among a number of corrosion-proof techniques, there are two main methods, namely, the electroplating of inert metals and coating of insulating coating material. The former takes advantage of the non-oxidizable tendency of an inert metal and electroplates the inert metal on the surface of a metal substrate in a manner that the metal substrate can be under the protection of said inert metal layer and its oxidation behavior can be lowered greatly. The second method involves applying a coating material over the surface of a metal substrate to insulate the metal substrate from direct exposure to air and achieve further the corrosion-proof effect. Conventionally, a polymer such as polyurethane (PU) is used as a coating material. PU is cheap and is used extensively, such as in adhesive binding sealant, thermal insulation materials, engineering plastics, rubber products and the like. For example, the building water-proofing industry usually uses PU as a water-proofing coating material. In recent years, polyurea (PUA) has been developed as a water-proofing coating material with effects such as preventing corrosion and the like better than traditional PU. In addition, polyurea exhibits stronger adaptation to various operation environments, especially moist environments, has better adhesion to different objects, and is more convenient use than traditional PU. Consequently, use of high purity polyurea in cladding a substrate can give a better corrosion-proofing effect. However, high purity polyurea is more expensive, which renders the cost of its use in corrosion-proofing treatments vastly different from that of traditional PU, and hence PUA can only be popularized with difficulty. Under such circumstances, private projects employ mostly cheaper traditional PU, or mixed polyurea/PU coating material, but results only into a durability difference of 5-10 times that of pure polyurea.

Polyurea is composed mainly of two components: isocyanate compounds and amino terminated compounds.

The isocyanate compounds may be an aromatic isocyanate compounds and an aliphatic isocyanate compounds, which may be present as a monomer, polymer, derivatives thereof, prepolymer or quasi-prepolymer, according to different operational needs.

Amino terminated compounds (compounds with terminal amino groups (—NH₂)) are selected from the group consisting of amino terminated polyether or polyetheramine (polyether with terminal amino group (—NH₂)) and amino terminated chain extender (chain extender with a terminal amino group (—NH₂)), wherein said chain extender is added in a ratio varying in accordance with the operational need, and it may be one selected from the group consisting of aliphatic amino terminated chain extender and aromatic amino terminated chain extender.

Polyurea is a macromolecular material that has repeat units with characteristic ureido linkage (—NH—CO—NH—) formed through well-known polymerization reaction (as shown in FIG. 4) of a compound with terminal isocyanate group (—NCO) and a compound with terminal amino group (—NH₂). Accordingly, macromolecular materials that comprise repeat units having characteristic ureido linkage (—NH—CO—NH—) belong to polyurea. Said polymerization reaction needs neither a catalyst nor heating, and can react rapidly to cure reactants into a film. Conventional polymerization for polyurea is shown in FIG. 4, where n is the molecular number, for example, if n is 1, it is meant that the compound with terminal isocyanato group (—NCO) and the compound with terminal amino group (—NH₂) are polymerized at a molecular ratio of 1:1 to form a molecular material having characteristic repeat unit with one ureido linkage (—NH—CO—NH—); and wherein R1, R2 as shown in FIG. 4 represents an aliphatic or aromatic substituent.

Clay is a material with a layered structure. By virtue of its layered structure, clay possesses physical properties of gas and water impermeabilities. These properties provide a barrier that can effectively extend the path and time water and oxygen take to permeating through the clay, and thereby the permeability of moisture and gas can be lowered. As such, clay has been studied to be applied in various aspects, such as composites, biochemical field, electronic assembly, environmental protection and the like. Clay is a silicate layered structure composed mainly of alumina (Al₂O₃) and silica (SiO₂), and has a particle diameter of about 1 μm. Each granule layer pile is stacked with hundreds to thousands layer of sheets. Each granule layer pile has about 850 silicate sheets on average. The inter-layer distance between one layer and another layer (d-spacing) is between about 6 Å and 17 Å, and predominately distributed over an inter-layer distance of 11 Å ˜13 Å. Further, based on ions trapped in the gap between its layers, clay can be classified into three major types, namely, cation exchange clay, anion exchange clay and neutral ion exchange clay. Among these types, cation exchange clay is predominate, with major cation as Li⁺, Na⁺, K⁺, Ca⁺, Mg²⁺, Ba²⁺, La³⁺, Ce²⁺ and the like, and may contain part of crystallization water. These cations provide excellent routes for organic modification of clay, i.e., for ion exchange reaction.

The excellent features of layered clay are derived from its special layered structure. As layered clay is blended with a macromolecular material, an inter-layered cationic exchange and interaction of ionic bond will occur. Especially, on the nano-scale level, many features not easy obtained in micro-scale may be presented one by one. Said features include gas barrier, UV protection, water resistance, heat resistance, stiffness, wear resistance, scratch resistance, corrosion-proofing, chemical resistance and the like. For materials used in coating, layered clay is an excellent thickener that gives remarkable advantages such as making operation or coating practice easier to do, the coating flatter, and greatly shortening manufacturing time and material usage.

However, layered clay has its limitation in application, since layered clay is an inorganic material and has hydrophilic properties, lacks affinity with lipophilic macromolecules, and it is relatively difficult to mix homogeneously with organic material. Accordingly, the layered clay has to be modified in order to obtain a homogeneously dispersed material.

In view of the foregoing, conventional materials exhibit many disadvantages and need to be improved urgently.

Although traditional coating material has been used widely today, their physical properties can not achieve the intended purpose. Accordingly, modification of known materials is a shortcut approach. For two different materials each with its own advantage, the basic concept of a composite resides on mixing these two materials to obtain a novel material having both advantages. In obtaining a good composite, the augmented property can be promoted only under the condition that these two component material are mixed relatively homogeneously. A nanocomposites is a material with the blending degree of its components being relatively homogenous up to a magnitude of 10⁻⁹ m (dispersed phase), which is much higher than that of 10⁻⁶ m in traditional composites. The basic definition of nanocomposites can be described as follows: 1. Particle size of dispersed material is within the range of nanometer size (1 nm ˜100 nm); 2. When Gibbsian solid phase is larger than 1, at least one phase state in its any dimension is within the range of nanometer size, especially between 1 nm ˜20 nm.

The properties of a nanocomposite coating material will vary depending on particle size, physical and chemical properties. Since a nanocomposite coating material is prepared by blending nano-scale materials, blending of different nano-scale materials finds each have different application properties, including novel applications of decontamination, self-cleaning, anti-bacterial, wear resistance, scratch-proof, water-proof, UV resistance and the like. Common nano-scale materials used are nano-clay that possesses layered structure, and its application on a surface of an object can form a scratch-proof and wear resistant coating; in addition, it may be used in packaging for foods to improve barrier properties against water and gas. Nonetheless, the distribution state of the nano-scale particles is a decisive factor for achieving the feature of the coating. Consequently, a technology capable for maintaining homogeneous dispersion of nano-scale particles in a coating material becomes a critical technology for nanocomposite coating material, and is also a threshold for the production and application of nanocomposite coating materials.

Since layered clay is a hydrophilic substance, while a polymer coating material belongs to a lipophilic substance, compatibility therebetween is accordingly not good. Even if the layered clay is ground to increase the contact area between these two materials, the non-homogeneity of the dispersed phase causes often the phase separation of the two phases. Further, bonds between the two materials to be mixed together each other are rarely present. Consequently, the layered clay added to the polymer fail to be dispersed effectively. Therefore, a modification method is useful to increase the compatibility between these two materials and is also a critical step. Among the other methods, a chemical method using layered clays as the subject to be modified is considered an easier method. As described above, since cations are trapped in the gap between silicate layers in the layered clay, these cations become the best subject to be used in the modification, namely, through cation exchange reaction, cations originally present between the silicate layers will be replaced with another cation having stronger organic character, thereby the organic character of the layered clay can be increased significantly. This type of modifier is known also as surfactants including such as intercalation agent or swelling agent. Since such modifiers exhibit both lipophilic and hydrophilic characteristics, they can combine hydrophilic layered clay and lipophilic polymers.

As described above, a layered clay has characteristics imparted from its layered structure, and meanwhile, polyurea exhibits excellent characteristics such as anticorrosive, gas barrier and inert properties. The inventor blends organophilic clay with polyurea to a nano-scale dispersion extent in order to obtain an anticorrosive nanocomposite coating material. Further, the better anticorrosive property of the coating material can lower the amount of raw materials used while achieve the anticorrosive effect originally required.

Accordingly, in view of various disadvantages derived from the conventional coating material, the inventor had thought to improve and innovate and finally, after studying intensively for many years, had developed successfully the anticorrosive nanocomposite coating material, and its preparation process according to the invention.

### SUMMARY OF THE INVENTION

One object of the invention is to provide an anticorrosive nanocomposite coating material, useful for coating a substrate so as to greatly reduce the corrosion rate of the substrate.

Another object of the invention is to provide a process for preparing said anticorrosive nanocomposite coating material, said process comprises of blending amino terminated compounds and modified layered clays, following by mixing homogeneously isocyanate compounds in appropriate ratio, to obtain said anticorrosive nanocomposite coating material.

An anticorrosive nanocomposite coating material and its preparation process that can achieve the above-mentioned objects comprises:

An anticorrosive nanocomposite coating material, comprising a polyurea, organophilic clay and suitable additives, wherein said nanocomposite coating material is useful to coat a substrate to greatly reduce its corrosion rate; and wherein said polyurea is synthesized by polymerizing amino terminated compound and isocyanate compound.

The process for preparing said anticorrosive nanocomposite coating material comprises the following steps:

step 1: providing suitable amount of amino terminated compounds and suitable amount of organophilic clay, and stirring homogeneously by a mechanical stirrer to obtain a mixed material;

step 2: blending the mixed material obtained in step 1 by a three-roll planetary mill several times to obtain a homogeneous material;

step 3: processing the homogeneous material, together with suitable ratio of isocyanate compounds and suitable additives through a reaction injection molding (RIM) technique, and after polymerization, obtaining said anticorrosive nanocomposite coating material.

In the reaction injection molding (RIM) of step 3 of the inventive preparation process, various raw materials are placed in its own storing tank, and said various raw material are injected separately and rapidly into the blending device under high pressure, mixed rapidly and homogeneously there, and then the resulting mixture is sprayed over the surface of a substrate under high pressure. During this process, since said various raw materials will react chemically with one another immediately upon mixing, the mixing and spraying over the surface of the substrate must proceed rapidly.

In blending suitable ratio of isocyanate compounds with homogeneous material obtained in step 2, amino terminated compounds are combined with isocyanate compounds quickly into a polyurea containing ureido linkage (—NHCONH—).

These features and advantages of the present invention will be fully understood and appreciated from the following detailed description of the accompanying Drawings.

### BRIEF DESCRIPTION OF THE DRAWINGS

FIG. 1 is the X-ray diffraction (XRD) spectra of a modified montmorillonite and an un-modified montmorillonite;

FIG. 2 is the XRD spectra of a nanocomposite coating material;

FIGS. 3A and 3B are transmission electron microscopy (TEM) photographs of a nanocomposite coating material;

FIG. 4 is a polymerization equation of a conventional polyurea, wherein n is the number of molecules; and wherein R1, and R2 represents an aliphatic or an aromatic moieties.

### DETAILED DESCRIPTION OF THE PREFERRED EMBODIMENT

The invention provides a process for preparing an anticorrosive nanocomposite coating material, comprising the following steps:

step 1: providing suitable amount of amino terminated compounds and suitable amount of modified layered clay, and stirring homogeneously by a mechanical stirrer to obtain a mixed material;

wherein said amino terminated compounds are compounds with terminal amino group (—NH₂), and preferably, its major component is the mixture of polyetheramine and a chain extender, and wherein said chain extender has a terminal amino group (amino terminated compounds in said mixture are available from Huntsman under the tradename of Jaffamine® D-2000, Jaffamine® T-5000, Uuilink® 4200 and Ethacure® 100 and the like);

wherein said amino terminated compounds can be synthesized chemically or is commercially available, such as from Huntsman, UOP, BASF, Albemarle Corporation and the like;

wherein said organophilic clay comprises 2-14 wt % of total weight of said mixed material;

wherein said organophilic clay can be obtained by modifying a commercial layered clay with a modifier, or is commercially available organophilic clay, such as Nanocor, PAI KONG NANO TECHNOLOGY CO., LTD. and the like;

wherein said layered clay may be one selected from the group consisting of smectite clay, vermiculite, halloysite, sericite or mica; wherein said smectite clay may be one selected from the group consisting of montmorillonite, saponite, beidellite, nontronite or hectorite, and preferably, montmorillonite;

wherein said modifier may be one selected from the group consisting of ammonium salt modifier, phosphate modifier, and the like, which renders inorganic layered clay lipophilic to be dispersed readily in components of the inventive nanocomposite coating material; wherein said ammonium salt modifier is preferably selected from the group consisting of tetrakis(decyl)ammonium bromide, [CH₃(CH₂)₉]₄N(Br), CAS. No. 14937-42-9), methyl trialkyl(C₈-C₁₀) ammonium chloride (CAS. No. 72749-59-8), or dodecyldimethyl-2-phenoxyethyeammonium bromide (CAS. No. 538-71-6); and wherein said phosphate modifier is preferably selected from the group consisting of dodecyltriphenylphosphonium bromide (CH₃(CH₂)₁₁N(CH₃)₂(CH₂CH₂OC₆H₅)Br, CAS. No. 15510-55-1); the above-mentioned modifiers is available from UNI-ONWARD CORP.;

step 2: blending the mixed material obtained in step 1 by a three-roll planetary mill several times to obtain a homogeneous material; wherein the gap between rolls are 25˜30 μm, 12˜13 μm, and 3˜5 μm, respectively; and wherein the rotational speed of each roll is 150 rpm, 250 rpm, and 550 rpm, respectively;

In step 2, amino terminated compound is mixed homogeneously with organophilic clay, thereby amino terminated compounds can be forced further into the inter-layer gap of this organophilic clay;

step 3: processing the homogeneous material obtained in step 2, together with suitable ratio of isocyanate compounds and suitable additives through a reaction injection molding (RIM) technique, and after polymerization, obtaining said anticorrosive nanocomposite coating material;

wherein in the reaction injection molding (RIM) of step 3, various raw materials are placed in its own storing tank, and said various raw material are injected separately and rapidly into the blending device under high pressure, mixed rapidly and homogeneously there, and then the resulting mixture is sprayed over the surface of a substrate under high pressure; during this process, since said various raw materials will react chemically with one another immediately upon mixing, the mixing and spraying over the surface of the substrate must proceed rapidly;

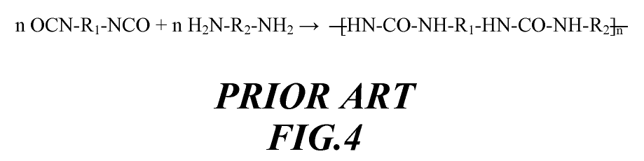

during blending process in step 3, a rapid and dramatic polymerization reaction will occur between said isocyanate compounds and said amino terminated compounds dispersed uniformly in the interlayer gap of modified layered clay layers to form a polyurea (as shown in FIG. 4); whereby molecular chains in the thus-formed polyurea extend rapidly, and these molecular chains will enlarge gaps between silicate sheets in the modified clay such that, as the interlayer distance in the modified layered clay is enlarged, a nano-scale polyurea/modified clay mixture blended homogeneously can be formed;

wherein said isocyanate compounds are compounds with terminal isocyanato group (—NCO), and preferably, its major components is selected from the group consisting of 4,4′-methylenebis(phenyl di-isocyanate) (MDI) and mixture of MDI-based prepolymers (said mixture is available from Huntsman under Rubinate® series of isocyanate compounds);

wherein said isocyanate compounds can be synthesized chemically or is commercially available from, for example Dow Chemical Company, Du Pont, Cytec, Bayer and the like;

wherein said amino terminated compounds are polymerized with isocyanate compounds in an appropriate weight ratio to form a polyurea with ureido linkage; wherein said appropriate weight ratio is preferably 1:1; wherein the weight percentage of said modified layered clay comprises 1-7 wt % of the total weight of the anticorrosive nanocomposite coating material;

wherein said suitable additives include, but not limited to, thickener, diluent, dispersant, flame retardant, anti-statics, colorant, release agent, fungicide, light stabilizer, antioxidant, anti-settling agent, rheological agent, filler, coupling agent, catalyst, leveling agent, anti-foam, and the like; wherein said additives can be added properly depending on the operational environment or properties requested by the customer.

The invention provides further an anticorrosive nanocomposite coating material obtained by the above-described preparation process, said material comprises polyurea, organophilic clay and suitable additives;

wherein said polyurea is synthesized by the polymerization of amino terminated compounds and isocyanate compounds;

wherein the weight ratio of said amino terminated compounds and isocyanate compounds is 1:1; wherein said modified layered clay comprises 1-7 wt % of the total weight of said anticorrosive nanocomposite coating material.

The invention will be illustrated in more detailed with reference to the following examples, provided that the invention is not limited by these preferred examples.

### Example 1

### The Preparation of Modified Montmorillonite

Conventionally, montmorillonite has been modified with a modifier based on the cationic characteristic in its interlayer space. This step is a cation exchange reaction, while the modifier selected belongs to cationic surfactant. When the cation exchange reaction is complete, the distance between layers in montmorillonite becomes more extended, which favors the intercalation of organic macromolecule therein.

A modified montmorillonite can be obtained by modifying a commercial montmorillonite with a modifier, or is a commercially available modified montmorillonite, such as from Nanocor, PAI KONG NANO TECHNOLOGY CO., LTD. To be illustrated in this example, a commercial montmorillonite was modified with a modifier.

The modification method was based on that described by Shir-joe, Liou et al. (Shir-joe, Liou and Jui-ming, Yeh, Study on the synthesis and properties of polyaniline/clay nanocomposites, master thesis 1991). Briefly, montmorillonite (Nanocor, Inc. USA.) was stirred in de-ionized (DI) water at room temperature for 24 hours to obtain an aqueous swollen montmorillonite suspension. Separately, tetrakis(decyl)ammonium bromide (CAS. No. 14937-42-9), or methyltrialkyl(C₈-C₁₀)ammonium chloride (CAS. No. 72749-59-8), or dodecyldimethyl-2-phenoxyethyl)ammonium bromide (CAS. No. 538-71-6), or dodecyltriphenylphosphonium bromide (CAS. No. 15510-55-1) to be used as a modifier was stirred in DI water at room temperature till dissolved. The solution was titrated with 1N HCl to pH=3˜4 under the monitoring of a pH meter, and then stirred at room temperature for 1 hour to obtain a modifier solution. All of these four modifiers mentioned above could achieve similar modification effect, i.e., increasing the interlayer distance in organophilic clay. In this example, methyltrialkyl(C₈-C₁₀)ammonium chloride (CAS. No. 72749-59-8) was used as the modifier to illustrate the modification of montmorillonite. The modifier (methyltrialkyl(C8-C10)ammonium chloride) solution was added into the aqueous swollen montmorillonite suspension, and the resulting mixture was stirred at room temperature for 24 hours. Flocculation was observed upon addition of the modifier solution into the aqueous swollen montmorillonite suspension. Therefore, the addition must be carried out slowly under strong stirring. Thereafter, the mixture was isolated in a centrifuge at 9000 rpm for 30 minutes. The pellet was rinsed with 30-fold volume of DI water. This procedure was repeated for 4˜5 times. This rinse-centrifuge procedure could remove excess modifier and the sodium cation being displaced. The montmorillonite obtained in the above process was dried in vacuum for 48 hours, followed by grinding in a micronizer to obtain a powder organically modified montmorillonite.

### Example 2

### Preparation of Nanocomposite Coating Material

The nanocomposite coating material was prepared by the following process:

step 1:

amino terminated compounds and the organically modified montmorillonite obtained in Example 1 were stirred homogeneously with a mechanical stirrer to obtain a mixed material;

wherein said amino terminated compounds were compounds with terminal amino group (—NH₂), and preferably its major components is a mixture of polyetheramine and a chain extender, and here, said chain extender might possess also a terminal amino group (amino terminated compounds in said mixture was available from Huntsman under the tradename of Jaffamine® D-2000, Jaffamine® T-5000, Uuilink® 4200 and Ethacure® 100);

wherein said organophilic clay comprised 2-14 wt % of the total weight of the mixed material;

step 2:

blending the mixed material obtained in step 1 in a first roll set at a rotation speed of 150 rpm and roll gap of 25˜30 μm, then in a second roll set at a speed of 250 rpm and roll gap of 12˜43 μm, and finally in a third roll set at a speed of 550 rpm and roll gap of 3˜5 μm, to obtain a homogeneous material;

step 3:

processing the homogeneous material obtained in step 2 and suitable ratio of isocyanate compounds as well as suitable additives through reaction injection molding (RIM) technique, and after completing of polymerization reaction, a nanocomposite coating material was obtained;

wherein said isocyanate compounds were compounds with terminal isocyanato group (—NCO), and preferably, its major component is 4,4′-methylenebis(phenyl isocyanate) (MDI) and mixture of MDI-based prepolymer (said mixture was purchased from Huntsman under the Rubinate® series of isocyanate compounds);

wherein said isocyanate compounds was reacted rapidly and dramatically with amino terminated compounds distributed uniformly in the interlayer space of the modified montmorillonite, as shown in FIG. 4, to form a polyurea with ureido linkage; consequently, macromolecular chains in polyurea were growing in the interlayer space of the modified montmorillonite, thereby the interlayer distance of the modified montmorillonite was further enlarged;

wherein the suitable ratio of said isocyanate compounds to said amino terminated compounds provided in step 1 was a weight ratio of 1:1;

wherein said suitable additives included, but not limited to, thickener, diluent, dispersant, flame retardant, anti-statics, colorant, release agent, fungicide, light stabilizer, antioxidant, anti-settling agent, rheological agent, filler, coupling agent, catalyst, leveling agent, anti-foam, and the like; wherein said additive was added properly depending on the operational environment or properties required by the customer.

The nanocomposite coating material obtained through the procedure described above comprised polyurea, modified montmorillonite and suitable additives; wherein in a preferred embodiments, said modified montmorillonite comprised 1-7 wt % of the total weight of said nanocomposite coating material; in the following examples, a nanocomposite coating material comprised 3 wt % of the modified montmorillonite was illustrated.

### Example 3

### Characterization of the Nanocomposite Coating Material

In this example, the nanocomposite coating material obtained as described in the above Example 2 was characterized at first by an X-ray diffraction instrument (XRD) to identify the nano-scale nature of the modified montmorillonite and the nanocomposite coating material. Then, transmission electron microscopy (TEM) was used to identify the nano-scale nature of the composite coating material, and the uniform dispersion of the modified montmorillonite in the polyurea. Said XRD and TEM characterization methods were based on the methods described previously by Shir-joe, Liou et al. (Shir-joe, Liou and Jui-ming, Yeh, Study on the synthesis and properties of polyaniline/clay nanocomposites, master thesis 1991). Briefly, described as follows:
1. X-ray diffraction analysis (XRD) of the modified montmorillonite and the nanocomposite coating material

At first, the powdered sample was ground with an agate mortar to a finer micro-powder, this facilitated the easy and flat adhesion of the powdered samples on the loading dish. The dish loaded with sample thereon was placed in an X-ray diffraction instrument (XRD) (Rigaku D/Max-3COD-2988N, a Wide-angle XRD). Conditions used in XRD measurement were: working voltage: 35 KV; working current: 25 mA; scanning over 1°˜10° at a scanning rate of 2°/min, taking one signal point every 0.05° (copper target, λ=1.54 Å). X-ray diffraction spectra (XRD) were analyzed, and the interlayer distance (d-spacing) in the sample was calculated in accordance with Bragg's Law.

Bragg's Law: 2 d sin θ=nλ, wherein λ is the wavelength of X-ray (λ=1.54, copper target); wherein θ is the incident angle; wherein n is an integer of 2, 3, and 4; and wherein d is the interlayer distance (d-spacing).

### XRD Characterization Results of the Modified Montmorillonite

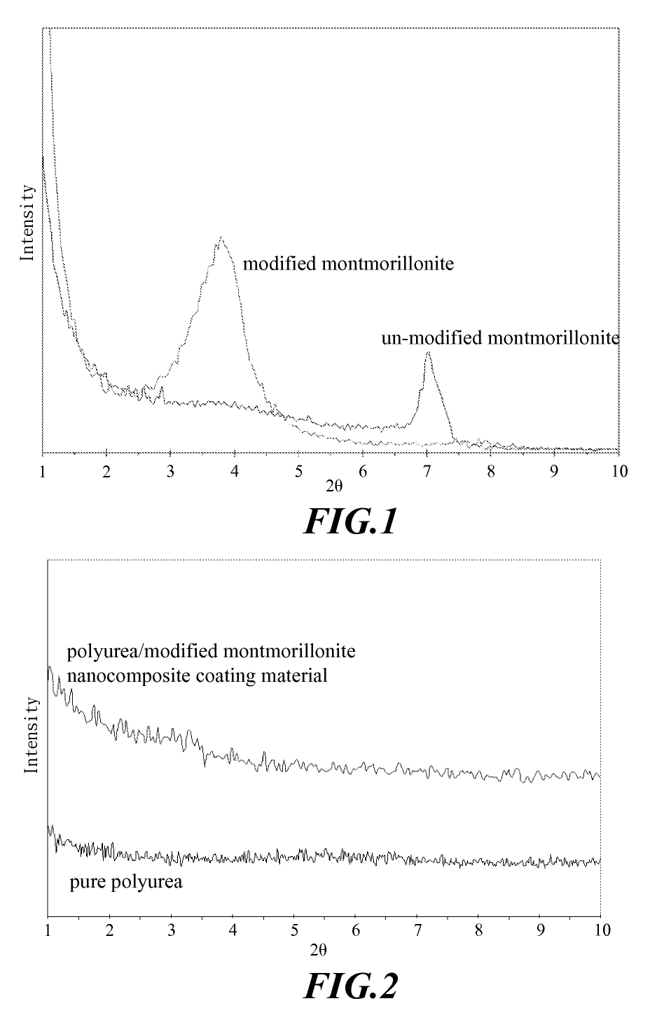

Referring to FIG. 1, samples tested were a modified montmorillonite and an un-modified montmorillonite, wherein the 2θ value of the un-modified montmorillonite was 7, and its interlayer distance (d) was 12.6 Å, i.e. about 1.26 nanometer; and wherein the 2θ value of the modified montmorillonite was 3.8, its interlayer distance (d) was 23.2 Å, i.e., about 2.32 nanometer. These results demonstrated that the interlayer distance of the montmorillonite modified with a modifier methyltrialkyl(C₈-C₁₀)-ammonium chloride (CAS. No. 72749-59-8) had been enlarged actually by the modifier, whereby the enlarged interlayer distance facilitated the easier entering of the isocyanate compound added in step 3 into the interlayer gap of this modified montmorillonite.

### XRD Characterization Results of the Nanocomposite Coating Material

Referring to FIG. 2, samples tested were polyurea/modified montmorillonite nanocomposite coating material obtained in Example 2 and pure polyurea. From the XRD analysis, it was known that these two groups of test samples did not show any signal over 2θ angle of 1˜10 degree, since no modified montmorillonite was present in pure polyurea, no signal could be generated; whereas polyurea/modified montmorillonite nanocomposite coating material also did not show any signal over 2θ angle of 1˜10 degree, indicating that 2θ angle between its clay layers was less or equal to 1, consequently, when n was 1, the interlayer distance (d) was about 88 Å, i.e. about 8.8 nanometer; accordingly, when said 2θ was less or equal to 1, these two test samples had a minimum interlayer distances higher or equal to 8.8 nanometer, which demonstrated that these two groups of coating material were nano-scale.
2. Transmission Electron Microscopy (TEM) analysis of Nanocomposite Coating Material

Before TEM characterization, the test samples must be embedded with a commercial special purpose embedding agent or commercial epoxy resin or polymethyl methacrylate (PMMA) to obtain sample to be sliced which facilitate slicing by a microtome. During slicing, the thickness of the slices was controlled within the range of 60˜90 nm with a thickness controller. After slicing repeatedly, a thin slice shiny platinum or golden color was obtained. The sample slices were scooped with a copper grid, and could be subjected then to a TEM test. Operation conditions of TEM (TEM, JEOL JEM1200EX) were: transmission electron beam at 120 KV, amplification at 50000×. after taking suitable image and adjusting focus, photographs could then be taken.

### TEM Characterization Results of the Nanocomposite Coating Material

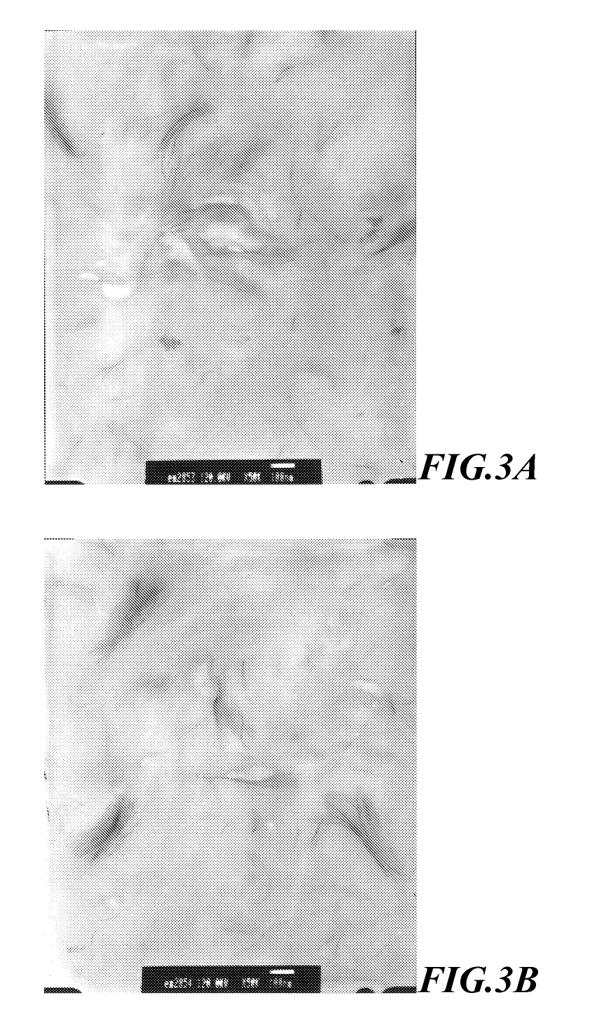

Referring to FIG. 3, TEM photographs at 50000× of polyurea/modified montmorillonite nanocomposite coating material obtained in Example 2 were shown, wherein FIGS. 3A and 3B were TEM photographs of the nanocomposite coating material (containing 3 wt % of organically modified montmorillonite) at different locations, respectively. In these photographs, black lines come from modified montmorillonite, other light color region without black lines were polyurea. As shown in FIGS. 3A and 3B, modified montmorillonites had been dispersed uniformly throughout polyurea through both of an exfoliation mode and an intercalation mode; wherein crystalline stack structure of the silicate layer in the clay was still present, this is referred as intercalation dispersion mode; on the other hand, when the silicate layer in the clay had no longer the crystalline stack structure, but presented in a disorderly spread state, it was known as exfoliation dispersion mode.

### Example 4

### Assessment of Anticorrosive Effects from Nanocomposite Coating Material

Since polyurea exhibits excellent anticorrosive characteristics, in this Example, cyclic voltammetry (CV, Radiometer Copenhagen, Voltalab 21 and VoltaLab 40) was used to test whether the nanocomposite coating material obtained in Example 2 had anticorrosive characteristics or not.

The corrosion test method used was based on one described by Shir-joe, Liou et al. (Shir-joe, Liou and Jui-ming, Yeh, Study on the synthesis and properties of polyaniline/clay nanocomposites, master thesis 1991). Briefly, a cold-rolled steel (CRS) was used as the test substrate. A suitable amount of a coating material to be tested was applied on the cold-rolled steel sheet to obtain a cold-rolled steel film sheet coated with the coating material. Then, the uncoated side of the cold-rolled steel film sheet was attached on a working electrode with a conductive silver adhesive and its outer edge was sealed with a commercial epoxy resin. As the epoxy resin was dried and cured, the sample was dipped in a 5 wt % NaCl solution (electrolyte), and a corrosion test was carried out for 30 minutes by using a calomel electrode as a standard reference electrode and a carbon rod as an auxiliary electrode. After the corrosion test, the potential detected by cyclic voltammetry was referred as free potential. Corrosion current scanning was carried out within the range of ±250 mV at a rate of 500 mV/min to obtain a cyclic voltammetry curve. Thereafter, data calculation yielded a Tafel curve, thereby data on corrosion potential, E_{corr}, corrosion current, i_{corr}, polarization resistance Rₚ, and corrosion rate (R_{corr}, MPY) of the test sample could be measured; wherein MPY indicated that the sample was corroded one mils per year (i.e. thousandths of an inch per year).

### Analytical Results on Anticorrosive Effect of the Nanocomposite Coating Material

As shown in Table 1, a bare cold-rolled steel sheet without coating material was used as the control group, and a polyurea-coated cold-rolled steel and cold-rolled steel coated with nanocomposite coating material obtained in Example 2 were used as test samples groups subjected to the corrosion test. The results indicated that the corrosion rate of the control group (a bare cold-rolled steel without coating material) was 0.18 MPY, corrosion rate of cold-rolled steel coated with 12 μm pure polyurea was 0.1226 MPY, and corrosion rate of cold-rolled steel coated with 10 μm nanocomposite coating material was 0.056 MPY. Accordingly, compared with the sample coated with thicker pure polyurea, cold-rolled steel coated with thinner nanocomposite coating material corroded more slowly and its corrosion rate was reduced by 2.2 fold. Thus, not only the anticorrosive characteristics of the inventive nanocomposite coating material were better than that of pure polyurea, but also its coating thickness was less.

TABLE 1
Analysis of anticorrosive effect of the coating material on a
substrate

| | Control | Pure | Nanocomposite |
|---|---|---|---|
| | group | polyurea | coating material |
| Corrosion | −671.5 | −527.4 | −465.1 |
| potential (mV) | | | |
| Polarization | 131.2 | 237.1 | 323 |
| resistance (KΩ × | | | |
| cm²) | | | |
| Corrosion current | 0.3858 | 0.2627 | 0.1199 |
| (μA/cm²) | | | |
| Corrosion rate | 0.1802 | 0.1226 | 0.056 |
| (MPY) | | | |
| Coating thickness | — | 12 | 10 |
| (μm) | | | |

The anticorrosive nanocomposite coating material, its preparation process and its application provided according to the invention exhibit following advantages over the above-recited documents and other conventional technology:
1. The anticorrosive nanocomposite coating material provided according to the invention has a better anticorrosive effect than that of pure polyurea, and thereby can extend the useful life of a substrate.
2. The anticorrosive nanocomposite coating material provided according to the invention gives its use amount less than that of pure polyurea, thereby the cost of the inventive anticorrosive nanocomposite coating material can be much lower.

While the detailed description provided above is directed to a possible embodiment of the invention, it should be understood that said embodiment is not construed to limit the scope of the invention as defined in the appended claims, and those equivalent embodiments or alteration, for example, types of additives, types of modifiers, and the like, that can be made without departing from the spirit and scope of the invention are intended to fall within the scope of the appended claims.

Accordingly, the invention not only demonstrates innovation in use, but also can provide a number of effects that improve upon conventional materials and techniques, and therefore, the application should meet sufficiency requirements of patentability in regards to novelty and non-obviousness, and should be eligible for the granting of patent rights.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. The anticorrosive nanocomposite coating material prepared by a process comprising the following steps:
step 1: providing amino terminated compounds and organophilic clay, and stirring homogeneously by a mechanical stirrer to obtain a mixed material;
step 2: blending the mixed material obtained in step 1 in a first roll set at a rotation speed of 150 rpm and roll gap of 25˜30 μm, then in a second roll set at a speed of 250 rpm and roll gap of 12˜13 μm, and finally in a third roll set at a speed of 550 rpm and roll gap of 3˜5 μm, to obtain a homogeneous material;
step 3: processing the homogeneous material, together with suitable ratio of isocyanate compounds and suitable additives through a reaction injection molding (RIM) technique, to obtain said anticorrosive nanocomposite coating material, said coating material comprising polyurea, organophilic clay and suitable additives.

2. The anticorrosive nanocomposite coating material as recited in claim 1, wherein said polyurea is synthesized through polymerization from amino terminated compound and isocyanate compound.

3. The anticorrosive nanocomposite coating material as recited in claim 2, wherein the weight ratio of said amino terminated compound to said isocyanate compound is 1:1.

4. The anticorrosive nanocomposite coating material as recited in claim 2, wherein said amino terminated compound is a mixture of polyetheramine and a chain extender.

5. The anticorrosive nanocomposite coating material as recited in claim 2, wherein said isocyanate compound is one selected from the group consisting of 4,4′-methylenebis(phenyl isocyanate) (MDI) and a mixture of MDI-based prepolymer.

6. The anticorrosive nanocomposite coating material as recited in claim 1, wherein said organophilic clay is a modified montmorillonite.

7. The anticorrosive nanocomposite coating material as recited in claim 1, wherein said organophilic clay comprises 1-7 wt % of the total weight of said anticorrosive nanocomposite coating material.

8. The anticorrosive nanocomposite coating material as recited in claim 1, wherein the minimum interlayer distance of said anticorrosive nanocomposite coating material is higher than 8.8 nanometers.

9. The anticorrosive nanocomposite coating material as recited in claim 1, wherein the dispersion extent of said modified layered clay comprises both of an exfoliation mode and an intercalation mode.
